(19) United States
(12) Patent Application Publication
(10) Pub. No.: US 2010/0057609 A1
(43) Pub. Date: Mar. 4, 2010

(54) Methods for Processing Online Loan Applications

(76) Inventor: Keith Sibson, Austin, TX (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/353,727

(22) Filed: Jan. 14, 2009

Related U.S. Application Data
(60) Provisional application No. 61/093,758, filed on Sep. 3, 2008.

(51) Int. Cl. G06Q 40/00

(52) U.S. Cl. 705/38; 705/39; 705/40

(57) ABSTRACT

In accordance with certain embodiments of the present disclosure, a method is provided. The method includes receiving a loan application from an applicant, the loan application including information of the applicant and based at least on the received loan application, determining creditworthiness of the applicant. The method also includes providing the received information of the applicant to a prepaid card provider for instantaneous disbursement of loan proceeds via a virtual prepaid debit card to the applicant by the prepaid card provider based at least on the creditworthiness of the applicant.

### RELATED APPLICATION

This application claims priority to and incorporates by reference in its entirety U.S. Provisional Patent Application No. 61/093,758 filed Sep. 3, 2008 entitled “Methods for Processing Online Loan Applications.”

### TECHNICAL FIELD

The present disclosure relates to financial transactions, and more particularly, to methods for processing online loan applications with debit accounts.

### BACKGROUND

With the advent of the Internet, online loan application processes have allowed consumers to quickly and more efficiently receive credit decisions from local and/or national lenders. Different types of loans, including short-term loans (e.g., personal “pay day loans” or installment loans), vehicle loans, mortgage loans, and/or commercial loans may be obtained almost instantly with the submission of a loan application.

However, the disbursement of the loan may take several days after submission of the loan application to reach the consumer. Typically, the lender will electronically send the money to a bank account associated with the consumer via ACH or other transfer methods; the loan may take a few days to post. Consumers who are in need of funds quickly must wait until the transaction has cleared their bank before being able to access the loan proceeds.

### SUMMARY

In accordance with certain embodiments of the present disclosure, a method is provided. The method includes receiving a loan application from an applicant, the loan application including information of the applicant and based at least on the received loan application, determining creditworthiness of the applicant. The method also includes providing the received information of the applicant to a prepaid card provider for instantaneous disbursement of loan proceeds via a virtual prepaid debit card to the applicant by the prepaid card provider based at least on the creditworthiness of the applicant.

In certain embodiments, the method may include receiving a request from a lender for creating a virtual prepaid debit card, wherein the request includes: (a) personal information of an applicant and (b) a loan amount to be credited to the virtual prepaid debit card; activating the virtual prepaid debit card for the applicant; and providing the virtual prepaid debit card to the applicant via a web-based interface.

In certain embodiments, a computer program embodied in computer readable media is provided. When the computer program is executed, the computer program may be configured to: receive a request from a lender for creating a virtual prepaid debit card, wherein the request includes at least one of (a) personal information of an applicant and/or (b) loan amount to be credited to the virtual prepaid debit card; activate the virtual prepaid debit card for the applicant; and provide the virtual prepaid debit card to the applicant via a web-based interface.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1A shows a method for processing online loan applications, in accordance with embodiments of the present disclosure;

FIG. 1B shows a method for disbursing loan proceeds for an approved online loan application, in accordance with embodiments of the present disclosure;

FIG. 2 shows an example process for issuing a prepaid debit card to an applicant, in accordance with embodiments of the present disclosure;

FIGS. 3A-3B show examples for providing options for how a loan is paid out to an applicant by the lender, in accordance with embodiments of the present disclosure;

FIG. 4 shows an example process for loading loan proceeds to a bank and/or a prepaid debit card, in accordance with embodiments of the present disclosure;

FIG. 5 shows an example process for disbursing loan proceeds via a prepaid debit card and/or a virtual debit card, in accordance with embodiments of the present disclosure;

FIG. 6 shows an example process for disbursing loan proceeds via a virtual debit card, in accordance with embodiments of the present disclosure;

FIG. 7 shows an example process for using a disbursed prepaid debit card at an ATM, in accordance with embodiments of the present disclosure;

FIG. 8 shows an example process for paying bills using a disbursed prepaid debit card, in accordance with embodiments of the present disclosure;

FIG. 9 shows an example process for adding money to a disbursed prepaid debit card, in accordance with embodiments of the present disclosure;

FIGS. 10A and 10B show examples for repaying the loan using a disbursed prepaid debit card, in accordance with embodiments of the present disclosure;

FIG. 11 shows an example communication between a lender and a prepaid card provider, in accordance with embodiments of the present disclosure;

FIG. 12 shows an example communication between a lender and a prepaid card provider for settling the total amount of loans disbursed, in accordance with embodiments of the present disclosure; and

FIG. 13 shows an example communication between the lender and the prepaid card provider for settling processing fees, in accordance with embodiments of the present disclosure.

### DETAILED DESCRIPTION

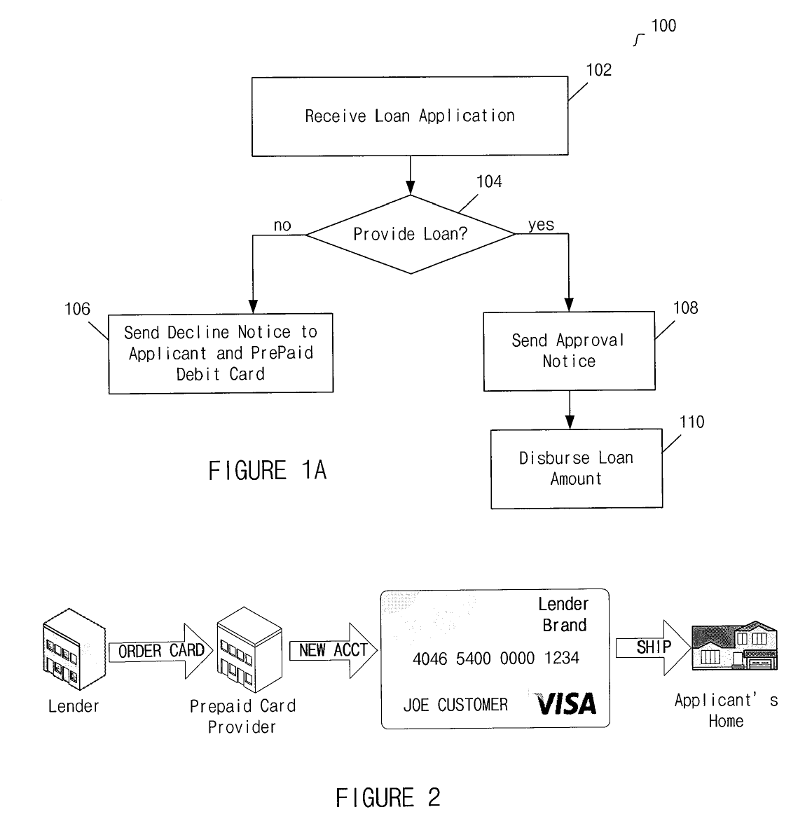

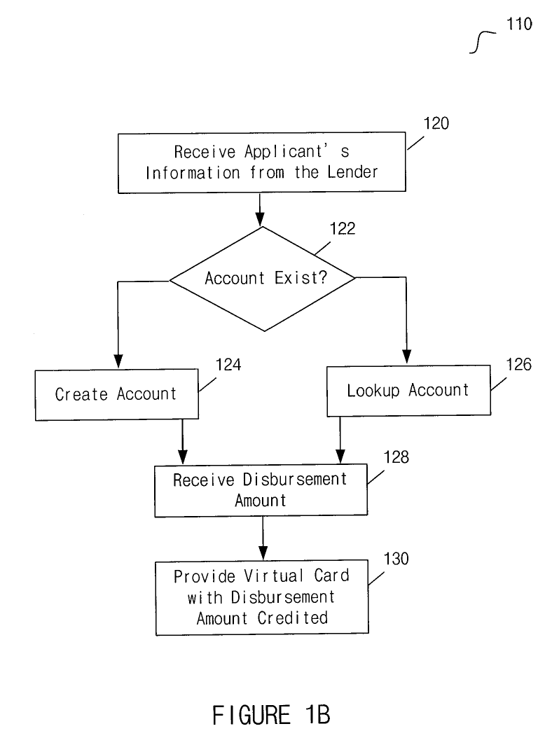

Preferred embodiments and their advantages are best understood by reference to FIGS. 1 through 12, wherein like numbers are used to indicate like and corresponding parts.

The present disclosure provides techniques for processing online loan applications. In one embodiment, an applicant may receive access to loan proceeds upon receipt of a loan approval almost instantaneously via, for example, a virtual debit card. A physical prepaid debit card may be sent to the applicant a relatively short time after loan approval (e.g., a day or two after approval), allowing the applicant additional methods of access to the loan proceeds.

The term “prepaid card provider” as defined and used in this disclosure refers to an issuing bank or entity acting on behalf of a bank issuing a prepaid debit card. The prepaid card provider may process transactions associated with the prepaid debit card. For example, when the prepaid debit card is used, the transaction information may be routed to the prepaid card provider and the value of the transaction may be subtracted from loan proceeds loaded on the card and/or the remaining balance on the prepaid debit card.

The term “lender” as defined and used in this disclosure refers to a lending institution (e.g., bank or payday lender) that may, among other things, (a) receive loan requests from an applicant, provide a credit decision (e.g., approval for loan or denial for loan) based at least on the merits of the loan request (e.g., information provided on a loan application); (b) disburse loan proceeds to the applicant (e.g., via depositing money into a bank account and/or loading a prepaid debit card with the loan proceeds) using for example, the prepaid card provider; and/or (c) receive payments on the loan by the applicants.

The term “lender” may also refer to merchant rebate handlers that may, among other things, (a) receive rebate information that may include a rebate amount from a merchant and/or a consumer; and (b) disburse the rebate amount using, for example, the prepaid card provider.

FIG. 1A depicts a method for processing online loan applications, in accordance with embodiments of the present disclosure. At step 102, a lender may receive an online loan application from an applicant via a network. The network may be implemented using hardware, software, or any combination thereof as, and may be a part of a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data), or any combination thereof. The network may transmit data (e.g., a loan application) using wireless transmissions and/or wire-line transmissions via any storage and/or communication protocol, including without limitation, Fibre Channel, Frame Relay, Asynchronous Transfer Mode (ATM), Internet protocol (IP), other packet-based protocol, small computer system interface (SCSI), Internet SCSI (iSCSI), advanced technology attachment (ATA), serial ATA (SATA), advanced technology attachment packet interface (ATAPI), serial storage architecture (SSA), integrated drive electronics (IDE), and/or any combination thereof.

At step 104, upon receipt of the loan application via the network, the lender may decide whether or not to extend a loan to the applicant. In one embodiment, the online application may include personal information of the applicant (e.g., name, home address, phone number, social security number, employment information, salary information, bank account information, other loan and/or credit card information, etc.) some or all of which may be used to determine creditworthiness by the lender. Based at least on some of the information provided, the lender may determine whether to grant a loan to the applicant and the amount of the loan extended to the applicant.

If the lender declines the application for a loan, the lender may notify the applicant at step 106. In connection with the notification, the lender may also provide information about a prepaid debit card (e.g., features, benefits, etc.) via, for example, a web API. In some embodiments, the lender may place a card order with a prepaid card provider, as shown in FIG. 2. The prepaid card provider may create a new account and issue a prepaid debit card to the applicant. Upon receipt of the prepaid debit card, the declined applicant may activate the prepaid debit card by loading (e.g., depositing money into an account associated with the prepaid debit card) prior to the commencement of any purchase transaction. The applicant may benefit from the convenience of the prepaid debit card for one or more reasons. For example, the prepaid debit card may require simple or no application and/or approval process, may not generally subjected to interest fees and restrictions, and/or may allow quick and easy transactions at a point of sale.

Steps 102, 104, and 106 also allow a lender to monetize declined loans by providing the applicant with a similar product. In one embodiment, the prepaid card provider may provide the lender incentives (e.g., referral fee, branded debit cards, etc.) for the referrals. Thus, the market acquisition channel provided by steps 102, 104, and 106 may benefit all parties involved including the applicants, lender, and prepaid card provider.

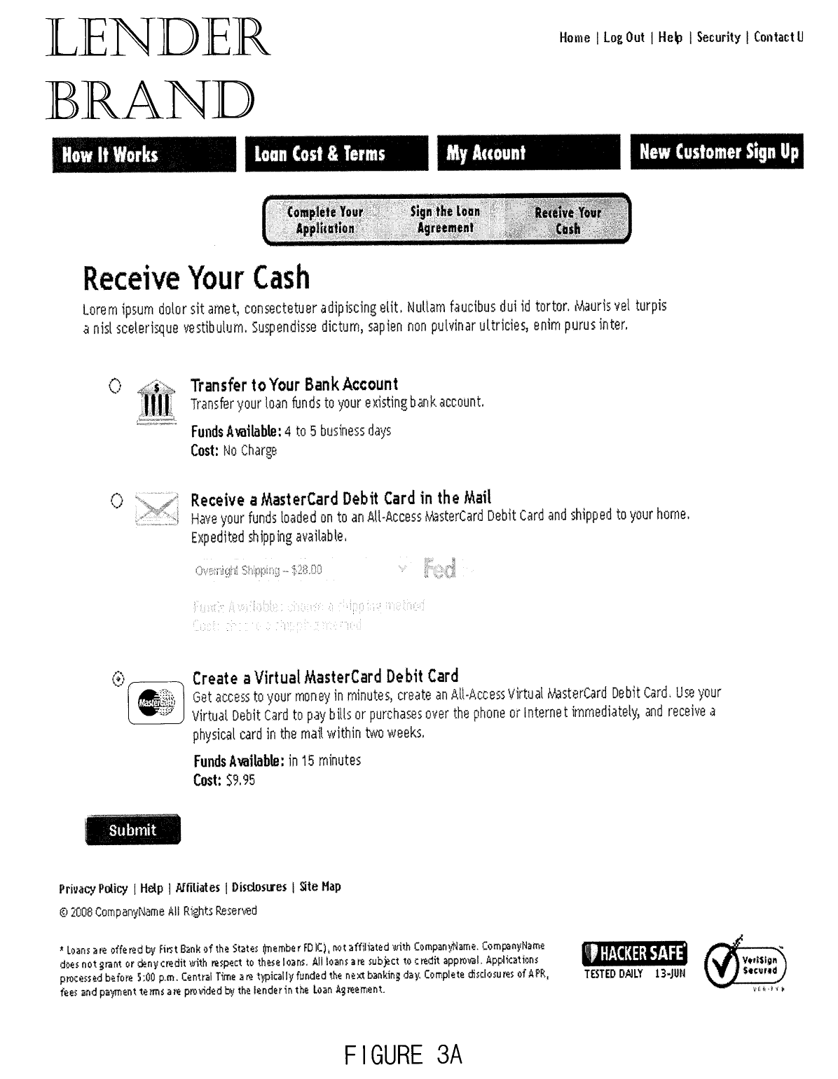

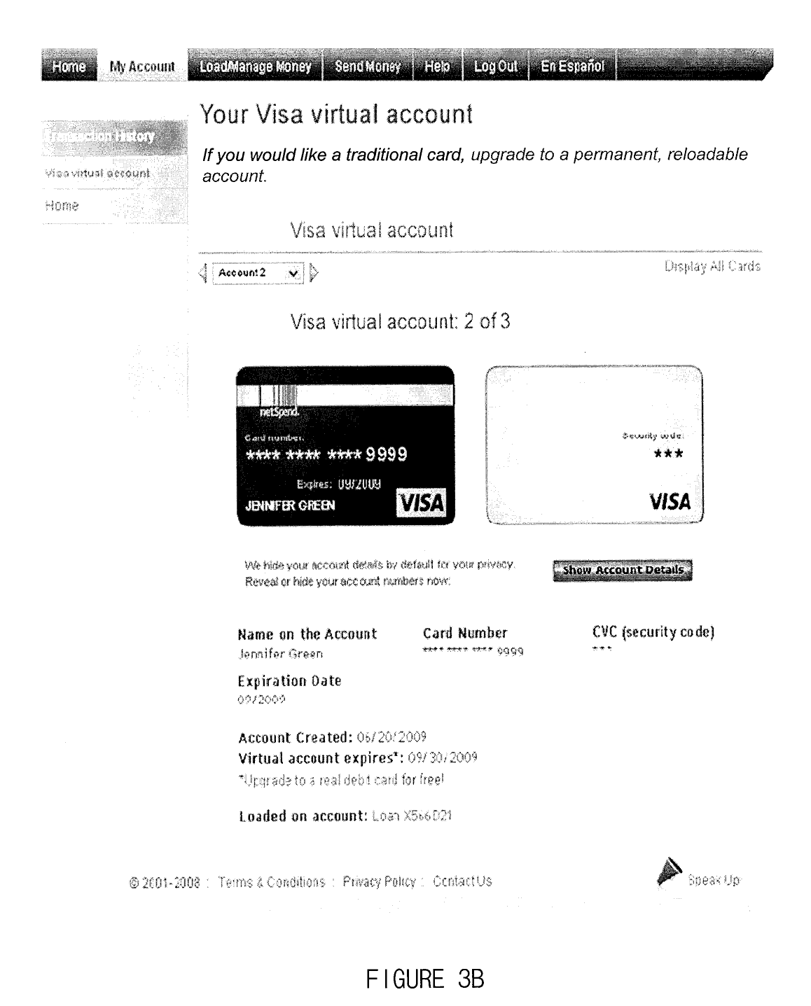

Referring again to FIG. 1A, at step 108, if the lender decides to approve the loan, the lender may notify the applicant of the approval via, for example, a GUI, pop-up window, or a webpage that provides options on how to disburse the loan, where the applicant may be provided one or more options on how the loan is paid out. Details of the loan payout options are described in more details with respect to FIGS. 3A-3B. At step 110, the lender may provide disburse the loan amount to the applicant as requested by the applicant in step 108. Details of the disbursement with respect to the prepaid card provider are described in more details in FIG. 1B.

Referring to FIG. 1B, a method for disbursing loan proceeds for an approved online loan applications is shown, in accordance with embodiments of the present disclosure. If the applicant has selected a substantially instantaneous disbursement of the loan via a virtual debit card, at step 120 (e.g., via the interface shown in FIG. 3A), the prepaid card provider may receive from the lender via, for example, XML or other suitable communication means, information related to the applicant including, for example, the name, address, social security number, date of birth, phone number, and/or other identification. At step 122, the prepaid card provider may determine if an account already exists for the applicant based at least on the received information. If the account does not exist, the method proceeds to step 124. If an account does exist for the applicant, the method proceeds to step 126.

At step 124, if the account does not exist, the prepaid card provider may set up a new account for the applicant based at least on the information provided by the lender at step 120.

At step 126, if the account already exists (e.g., applicant's has a previously issued virtual card or a physical prepaid card), the prepaid card provider may look up the account and may update the information of the applicant with the information provided by the lender at step 120.

At step 128, the prepaid card provider may receive the disbursement amount, e.g., the amount of the loan approved by the lender at step 104 of method 100. The disbursement amount may be sent at the same time as the applicant's information (step 120) or may be a separate communication via, for example, XML, between the lender and the prepaid card provider.

Upon receiving the disbursement amount, at step 130, the prepaid card provider may credit the account of the applicant and may provide via, for example, an interface, GUI, popup window, a virtual debit card to the applicant. In one embodiment, if an account already exists for the applicant, the prepaid card provider may replenish the account with the loan proceeds and may provide to the applicant the updated balance information via, for example, an interface (e.g., the interface shown in FIG. 3B).

If the account is new, the prepaid card provider may update the account information with the new balance from the loan proceedings and may provide to the applicant information relating to the new account via, for example, the interface shown in FIG. 3B.

Steps 120 through 130 may be automated and may provide the applicant an almost instantaneous virtual debit card upon the approval decision by the lender.

Some or all of the steps of the flowchart of FIGS. 1A and/or 1B may be implemented using any system (e.g., one or more computers connected to a network and configured to execute instructions of a software) operable to implement the method. In certain embodiments, the method illustrated in FIGS. 1A and 1B may be implemented partially or fully in software embodied in tangible computer readable media. As used in this disclosure, “tangible computer readable media” means any instrumentality, or aggregation of instrumentalities that may retain data and/or instructions for a period of time. Tangible computer readable media may include, without limitation, random access memory (RAM), read-only memory (ROM), electrically erasable programmable read-only memory (EEPROM), a PCMCIA card, flash memory, direct access storage (e.g., a hard disk drive or floppy disk), sequential access storage (e.g., a tape disk drive), compact disk, CD-ROM, DVD, and/or any suitable selection of volatile and/or non-volatile memory and/or a physical or virtual storage resource

FIGS. 3A-3B show example process interfaces for communicating a loan disbursement to an applicant, in accordance with embodiments of the present disclosure. Upon approving a loan application, the lender may provide an interface (e.g., a GUI), a pop-up window, and/or a webpage to the applicant presenting several options to receive funds from the loan as shown in FIG. 3A. In one embodiment, the interface may provide the applicant the options of: (a) transferring loan proceeds to a bank account, which typically takes multiple business days; (b) receiving a prepaid debit card (e.g., via mail) credited with some or all of the loan proceeds, which typically takes 12-24 hours; and/or (c) receiving a virtual debit card credited with some or all of the loan proceeds, which may be available to the applicant instantly or within few minutes of selection. In each of the provided options, the lender may charge a premium for the disbursement option. For example, if the applicant selects the virtual debit card, the lender may charge a convenience fee that may be deducted from the loan amount or may be charged to the applicant at a later time. The applicant may select one or more of the disbursement options provided in the interface (e.g., receive a prepaid debit card and/or a virtual debit card).

The lender may receive the applicant's requested option for disbursement of loan proceeds (e.g., via the interface shown in FIG. 3A) and may send a request (e.g., via XML connection or other suitable connections between the lender and the prepaid card provider) to a prepaid card provider to disburse the loan proceeds in accordance with the applicant's selection. In some embodiments, the lender may communicate to the prepaid card provider one or more of the following: (a) a request for a physical prepaid debit card to be delivered to the applicant; (b) a request for a virtual debit card, and/or (c) an amount to be credited to an existing physical prepaid debit card and/or the virtual debit card. Using at least the information provided by the lender, the prepaid card provider may establish an account for the applicant.

In one embodiment, the prepaid card provider may deliver to the applicant a virtual debit card via an interface, as shown in FIG. 3B. The virtual debit card may have similar or the same features as a physical prepaid debit card including, for example, a cardholder name, a card number, an expiration date, a card verification value (CVV) and/or a card verification code (CVC) number, and the like. The virtual debit card may also include some or the entire loan proceeds credited to the virtual prepaid debit card account's balance, and may be used like a prepaid debit card upon receipt by the applicant for card-not-present transactions (e.g., immediate phone or online payments and/or purchases). For example, any purchases, bill payments, ATM withdrawals, or other transactions may be deducted from the amount credited to the virtual prepaid debit card.

The prepaid card provider may also receive from the lender a request to create an account and issue a physical prepaid debit card to the applicant. The prepaid debit card may be credited with some or all of the loan proceeds credited to the card. In one embodiment, if an applicant receives both a virtual prepaid debit card and a prepaid debit card, the physical prepaid debit card and the virtual prepaid debit card may be assigned different personal account numbers (PAN) but transactions (e.g., point-of-sale transactions, bill pay, ATM withdrawals, etc.,) may be debited from a single account balance representing proceeds from the loan. As another example, once the applicant receives the prepaid debit card and provides authenticating credentials (e.g., social security number, phone number, loan application number, etc.), the virtual prepaid debit card may be deactivated and may no longer be used. In some embodiments, the virtual prepaid debit card may have an expiration period. For example, the virtual prepaid debit card may have an expiration period of a few days, weeks, or months and may coincide with the issuance of the physical prepaid debit card sent to the applicant by the prepaid card provider.

In some embodiments, the interface may allow an applicant to choose a physical prepaid debit card after the loan disbursement to a virtual card, as shown in FIG. 3B. The applicant may log into a website provided by the prepaid card provider and may select an option to have a physical, reloadable, prepaid card issued by the prepaid card provider and sent to the applicant. The applicant may provide some information such that the prepaid card provider may verify the identity of the applicant. Upon verifying the request by the applicant, the prepaid card provider may issue a physical, prepaid card to the applicant. In some embodiments, the prepaid card provider may establish a new account (e.g., separate from the virtual debit card) and send to the applicant a prepaid debit card. Alternatively, the prepaid card provider may link the physical prepaid debit card with the virtual card (e.g., same underlying account number).

The physical, prepaid card may have a balance of all or a portion of the loan proceeds where any purchases, payments, or point of sale transactions made by the applicant with the physical, prepaid card may be deducted from the balance.

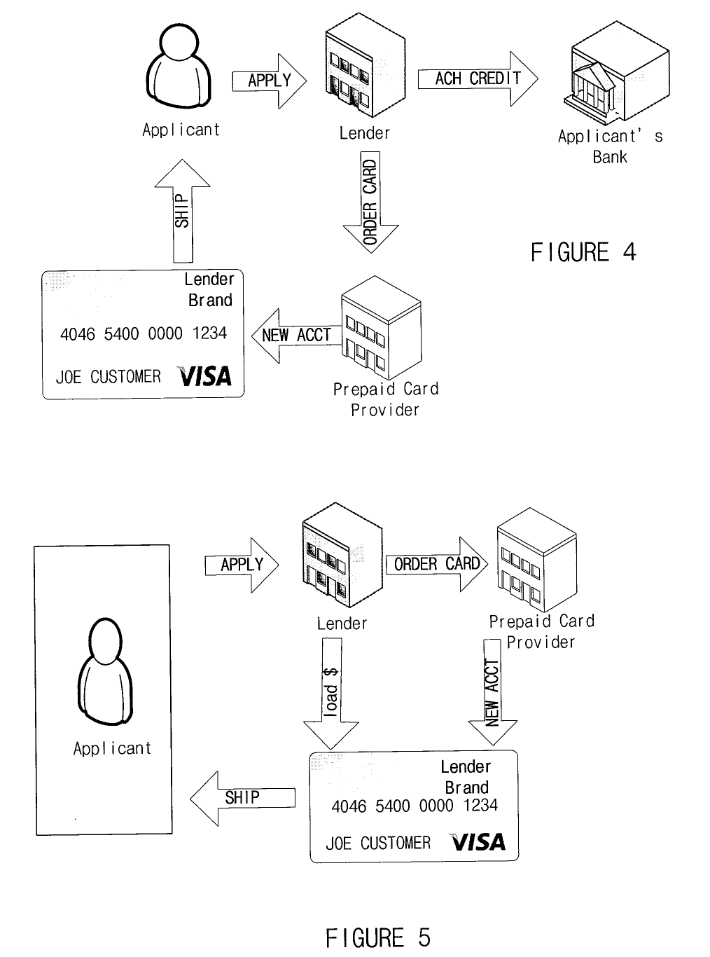

FIGS. 4-6 show various embodiments for practicing method 100 as shown in FIG. 1 in accordance with embodiments of the present disclosure. Referring to FIG. 4, the applicant may apply for a loan via, for example, the lender's website, and upon approving the loan application (step 104), an interface may be provided to the applicant where the applicant may select how the loan is disbursed (e.g., to a bank account, a virtual debit card, and/or a physical debit card). If the applicants select routing the loan disbursement to a bank account, the lender may initialize a transfer of money into the applicant's banking account (e.g., checking account, savings account, etc.) with all or a portion of the loan proceeds. Alternatively, the lender may send a paper check to the applicant in the amount of the loan for the applicant to cash and/or deposit at the applicant's bank.

Additionally, the lender may also order a prepaid debit card from a prepaid card provider. The lender may provide the prepaid card provider with information provided by the applicant on the applicant's application form (e.g., the online application transmitted at step 102). For example, the lender may provide the prepaid card provider with the name, address, phone number, and/or other information regarding the applicant. In some embodiments, the lender may also provide a credit (e.g., a deposit amount) for the prepaid debit card. All or a portion of the loan proceeds may be applied as a deposit to the prepaid debit card, and any purchases, payments, or point of sale transactions made by the applicant with the prepaid debit card may be deducted from the deposited amount. The prepaid card provider may establish a new account and send to the applicant a prepaid debit card.

In some embodiments, an applicant may not have a bank account or may not want to use a bank account to receive the loan proceeds, as selected in the interface shown in FIG. 3A. In such a scenario, the lender may provide an alternative means to deliver any approved loan proceeds to the applicant. The disbursement of loan proceeds via prepaid debit cards may provide a way to disburse loan proceeds to such an applicant.

FIG. 5 shows an example process for disbursing loan proceeds and an associated prepaid debit card to an applicant, in accordance with embodiments of the present disclosure. Upon approving a loan application and a card selection by the applicant, the lender may contact a prepaid card provider and provide information about the applicant to establish a new prepaid debit card account. The lender may provide, for example, the name, address, phone number, and/or other information regarding the applicant. Additionally, the lender may provide the prepaid card provider with the amount of loan proceeds to be credited to the prepaid card. Once the account is established by the prepaid card provider and a card is made, the prepaid card provider may deliver the card to the applicant for use.

In some embodiments, an applicant may need immediate access to the loan proceeds and may select, via the interface shown in FIG. 3A a virtual prepaid debit card for use. The present disclosure provides a virtual debit card to the applicant at the time of approval, where the virtual debit card may be used in a similar manner as a prepaid debit card.

FIG. 6 shows an example process for disbursing loan proceeds via a virtual debit card. In one embodiment, upon receipt and approval of an application, the lender may request the following: issuing a new debit card, reloading the issued new card with a loan amount, and/or a request for a virtual debit card based at least on an applicants selection from an interface provided by the lender (e.g., interface shown in FIG. 3A). Upon receiving the information provided by the lender, the prepaid card provider may send to the applicant a virtual debit card via an email, a user interface (as shown in FIG. 3B) and/or any other means almost instantaneously after the application is approved. The prepaid card provider may subsequently send, via a mail courier, the actual prepaid debit card at a later time or as requested by the applicant (as shown in FIG. 3B).

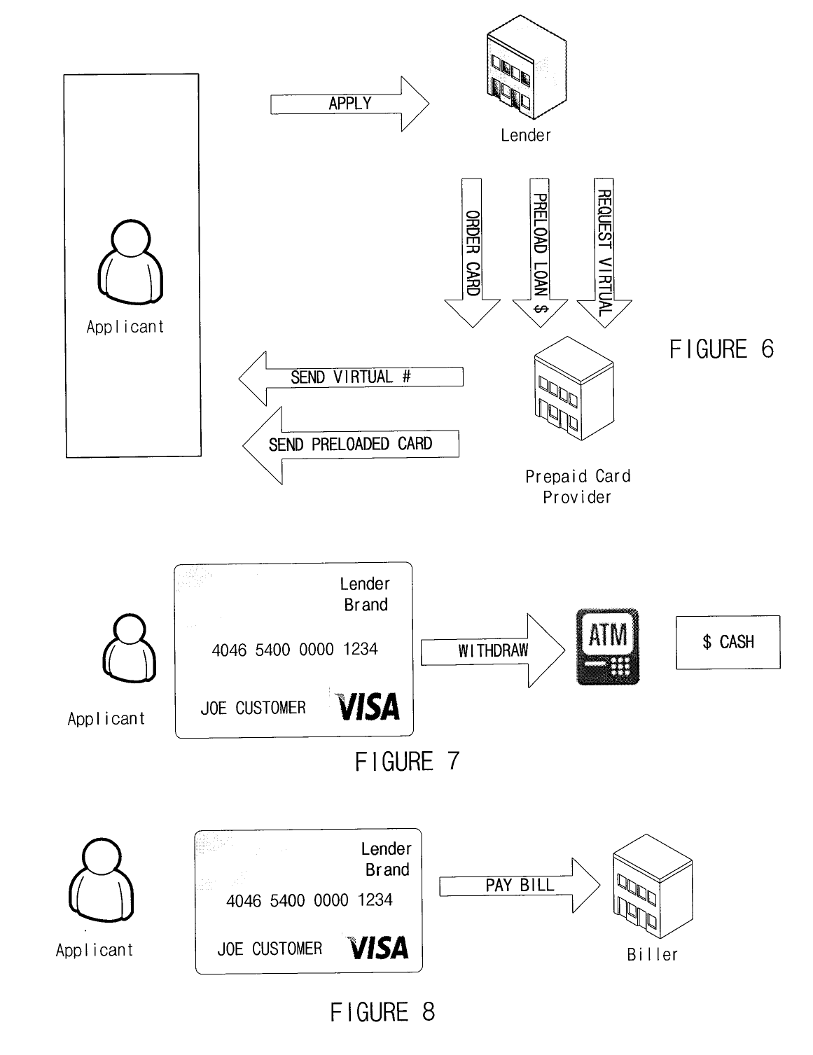

FIG. 7 shows an example process for using an issued prepaid debit card credited with loan proceeds. As shown in FIG. 7, the applicant may withdraw cash from an ATM using a conventional technique such as entering a PIN number unique to prepaid debit card. Similarly, the prepaid debit card may be used at other points of sale (e.g., at a storefront, kiosk, over a network, phone orders, etc.) involving a card reader configured to read data (e.g., data embedded into a magnetic strip of the prepaid debit card). The amount withdrawn or otherwise used in a point of a sale transaction may be deducted from the loan proceeds credited on the card.

FIG. 8 shows another example process for using an issued prepaid card, in accordance with embodiments of the present disclosure. The prepaid debit card with all or a portion of the loan proceeds credited may be used to pay bills (e.g., online with a virtual debit card and/or with a physical prepaid debit card). The applicant may provide the account number associated with the physical and/or virtual prepaid debit card (e.g., the sixteen-digit number on the face of the card) to a biller via, for example, phone, a kiosk, a storefront, over a network or other means. The amount of the bill payment(s) may be deducted from the credit balance on the prepaid debit card.

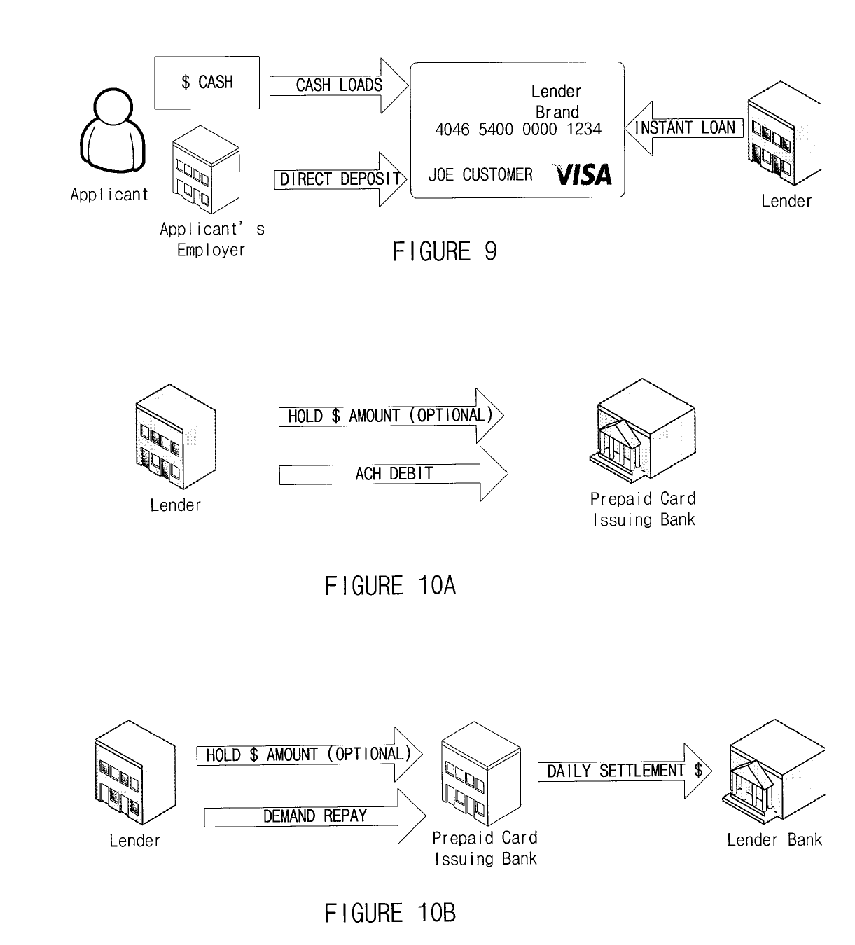

In the same or alternative embodiments, the applicant and/or a third party may also deposit money to replenish the balance on the card. Referring to FIG. 9, the applicant may deposit money to increase the available balance on the prepaid debit card. In one embodiment, the applicant may deposit money at a kiosk, ATM machine, a storefront associated with the prepaid debit card, and/or via a phone (e.g., by providing an account number of a bank account). Alternatively or in addition, all or a portion of an applicant's paycheck may be added to the balance on the prepaid debit card. For example, the applicant may provide account information to his or her employer to set up a direct deposit to the account associated with the prepaid debit card.

In some embodiments, a lender may also credit the prepaid debit card with proceeds from subsequent loan(s). For example, if the applicant has taken out loans with the lender in the past, and a prepaid debit card (e.g., physical and/or virtual) was issued in connection with past transaction(s), the lender may send an electronic notification to the prepaid card provider and the loan proceeds may be credited immediately to the account associated with the prepaid debit card.

As another example, the lender may also debit from the balance of the account associated with the prepaid debit card, for example, to service payments for a loan for which a prepaid debit card was issued. Referring to FIGS. 10A-10B, examples for repaying a loan using a issued prepaid debit card, in accordance with embodiments of the present disclosure, are shown. In one embodiment, the applicant may initiate a payment (e.g., via a website) to the lender before the due date, or the lender may automatically initiate a repayment transaction on or before the due date. The lender may send a payment request to applicant's bank, and the amount of the payment may be credited to a bank account or other suitable account of the lender. Some or all of the payment amount may also be directly deducted from the available balance on the prepaid debit card by an electronic transaction.

In some embodiments, referring to FIG. 10A, the lender may issue a hold for the amount of the payment and forward the hold to the prepaid card issuing bank. The prepaid card issuing bank may reserve the amount of the hold aside from the available balance of the card and may subsequently credit an account associated with the lender with the payment amount based on an ACH transaction for the same amount, reconciled with the reserved amount. The lender may have similar processes in place to settle a loan repayment with a bank or prepaid card provider—allowing a simple transaction to process using the embodiments of the present disclosure.

In some embodiments, the loan payment may be automatically and immediately deducted from the available balance of the prepaid debit card on a due date. Referring to FIG. 10B, the sender may send a demand repay to the prepaid card issuing bank for the amount of the payment.

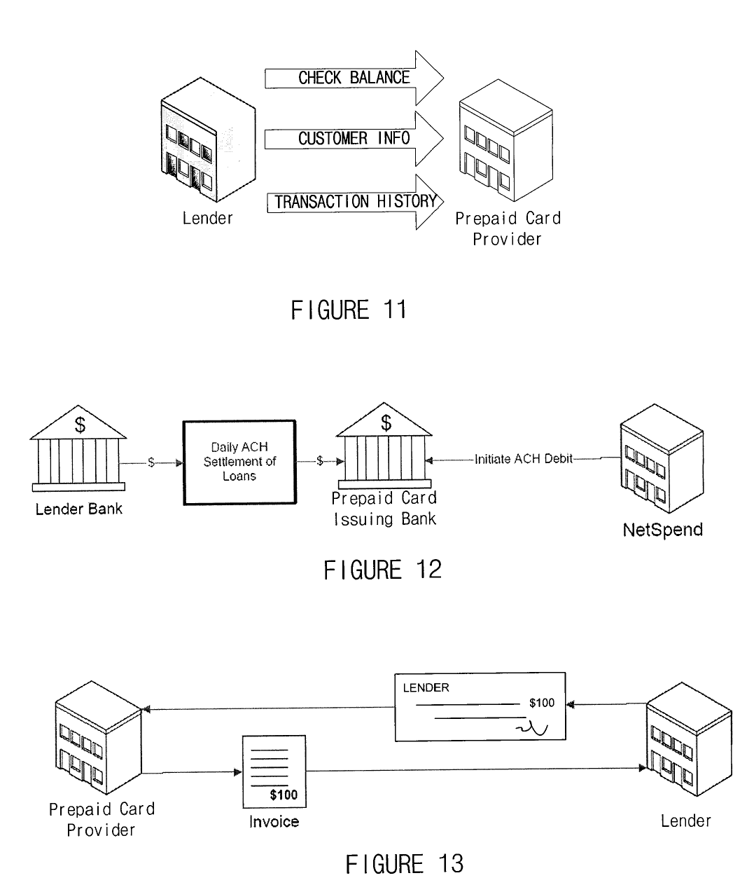

Referring to FIG. 11, an example communication between a lender and a prepaid card provider is shown in accordance with embodiments of the present disclosure. The lender may request various information about an applicant from the prepaid debit card provider. For example, the lender may send a balance request for a specific account, which allows the lender to receive effective repayment (e.g., full or partial payments) on loans in real-time. The repayment processing based on account balance may eliminate or reduce non-sufficient fund charges typically seen when a lender deducts from an applicant's bank account using ACH.

Additionally, the lender may have direct access to the account status of a new or existing applicant at any given time. Referring again to FIG. 11, the lender may determine information or status of an account by sending a request to a prepaid card provider. The request may include, for example, customer information and/or transaction history of an account as well as the applicant's permission to access the information. Based at least on the information provided by the prepaid debit card provider, the lenders may decide whether to approve an application.

FIG. 12 shows another example communication between a lender and a prepaid card provider, and in particular, settling the total amount of loans disbursed between the lender's bank and the prepaid card issuing bank, in accordance with embodiments of the present disclosure. In one embodiment, at a predetermined time interval (e.g., daily, weekly, semi-monthly, monthly, etc.), a bank associated with the lender and a bank associated with the prepaid card provider may settle the total amount disbursed for one or more applicants over the predetermined time interval. The prepaid card provider may initiate an ACH debit to the lender's bank and the lender's bank may settle the amount by depositing funds to the bank associated with the prepaid card provider.

FIG. 13 shows another example communication between the lender and the prepaid card provider. In some embodiments, the lender may agree to pay a processing fee associated with each virtual and/or physical prepaid card issued by prepaid card provider to applicants of the lender. At a predetermined time interval (e.g., daily, weekly, monthly, etc.), the prepaid card provider may send an invoice to the lender for the amount of the processing fee. The invoice may be sent electronically (e.g., submitted via a webpage and/or sent via electronic mail), faxed, and/or an ACH debit may be initiated by the prepaid card provider. The lender may submit payment via check, ACH settlement, or other suitable means.

Although the present disclosure has been described in detail, it should be understood that various changes, substitutions, and alterations may be made hereto without departing from the spirit and the scope of the invention as defined by the appended claims.

What is claimed is:

1. A method, comprising:
receiving an loan application from an applicant, the loan application comprising information of the applicant;
based at least on the received loan application, determining creditworthiness of the applicant; and
based at least on the creditworthiness of the applicant, providing the received information of the applicant to a prepaid card provider for instantaneous disbursement of loan proceeds via a virtual prepaid debit card to the applicant by the prepaid card provider.

2. A method according to claim 1, further comprising providing the applicant a loan disbursement option comprising at least one of:
disbursement to a bank account;
disbursement via a virtual prepaid debit card; and
disbursement via a physical prepaid debit card.

3. A method according to claim 2, wherein providing the applicant a loan disbursement option comprises providing the applicant a web-based interface configured to display the loan disbursement option.

4. A method according to claim 1, further comprising forwarding an ACH debit request to the prepaid card provider, the ACH debit request being a loan payment amount.

5. A method according to claim 4, wherein the loan payment amount is deducted from a balance of the virtual prepaid debit card.

6. A method, comprising:
receiving a request from a lender for creating a virtual prepaid debit card, wherein the request includes:
personal information of an applicant;
a loan amount to be credited to the virtual prepaid debit card;
activating the virtual prepaid debit card for the applicant; and
providing the virtual prepaid debit card to the applicant via a web-based interface.

7. A method according to claim 6, wherein activating comprises creating a new account for the applicant based at least on the personal information received by the lender.

8. A method according to claim 6, wherein activating comprises crediting a pre-existing virtual debit card for the applicant with the loan amount.

9. A method according to claim 8, further comprising crediting the pre-existing account with the amount received from the lender.

10. A method according to claim 6, further comprising:
providing the applicant a web-based interface configured to display the loan disbursement option;
receiving from the applicant a request for a physical prepaid debit card; and
based at least on the request, providing a physical prepaid debit card to the applicant.

11. A method according to claim 10, wherein receiving the request for a physical prepaid debit card comprises receiving a request via a web-based interface.

12. A method according to claim 10, wherein the physical prepaid debit card is credited with at least a portion of the loan amount.

13. A method according to claim 10, wherein the physical prepaid debit card is associated with the virtual prepaid debit card.

14. A method according to claim 4, further comprising receiving an ACH debit request from the lender, the ACH debit request being a loan payment amount.

15. A method according to claim 14, further comprising deducting the loan payment amount from a balance of the virtual prepaid debit card.

16. A computer program embodied in computer readable media and when executed, configured to:
receive a request from a lender for creating a virtual prepaid debit card, wherein the request includes at least one of:
personal information of an applicant;
a loan amount to be credited to the virtual prepaid debit card;
activate the virtual prepaid debit card for the applicant; and
provide the virtual prepaid debit card to the applicant via a web-based interface.

17. A computer program according to claim 16, wherein to activate the virtual prepaid debit card comprises creating a new account for the applicant based at least on the personal information received by the lender.

18. A computer program according to claim 16, wherein to activate the virtual prepaid debit card comprises crediting a pre-existing virtual debit card for the applicant with the loan amount.

19. A computer program according to claim 16, further configured to:
receive from an applicant a request for a physical prepaid debit card; and
based at least on the request, providing a physical prepaid debit card to the applicant.

20. A computer program according to claim 16, further configured to:
receive an ACH debit request from the lender, the ACH debit request being a loan payment amount; and
deduct the loan payment amount from a balance of the virtual prepaid debit card.
